(19) United States
(12) Patent Application Publication
(10) Pub. No.: US 2019/0344463 A1
(43) Pub. Date: Nov. 14, 2019

(54) METHOD FOR CHECKING THE CORRECT OPERATION OF A PRE-CUTTING AND REWINDING MACHINE

(71) Applicant: FUTURA S.P.A., Capannori (IT)

(72) Inventor: Giovacchino GIURLANI, Capannori (IT)

(73) Assignee: FUTURA S.P.A., Capannori (IT)

(21) Appl. No.: 16/474,183

(22) PCT Filed: Jan. 23, 2018
(86) PCT No.: PCT/IT2018/000009

§ 371 Date: Jun. 27, 2019

(30) Foreign Application Priority Data
Feb. 2, 2017 (IT) 102017000011567

(51) Int. Cl. B26D 5/06; B26F 1/20

(52) U.S. Cl. CPC B26D 5/06; B26D 7/265; B26F 1/20

(57) ABSTRACT

A method for checking the correct operation of a pre-cutting device in a plant for production of logs of paper material. The method includes realization and assembly of the pre-cutting device, with relative positioning and adjustment of said first and second element; activation of the pre-cutting device with the measurement of the vibrations emitted relating to the interaction between said first and said second element; storage of at least a value or of a set of values relative to the measurement of the vibrations corresponding to an optimal or reference operating configuration of the device; measuring, the values of the vibrations emitted by the interaction between said first and second element and comparison with the value or set of values related to the reference operating configuration, with the emission of a signal if there is a non-correspondence between the detected value and the reference value or set of reference values.

The present invention relates to the technical field of rewinders for the production of logs made of paper material and, in particular, relates to a method and an apparatus for checking the correct execution of the pre-cutting lines.

It is known that the production of logs of paper material, from which, for example, rolls of toilet paper or rolls of kitchen paper are obtained, involves feeding a paper web, formed by one or more superimposed paper plies, along a predetermined path over which various operations are performed before proceeding to the formation of the logs, including a transversal pre-incision of the web to form pre-cut lines which divide it into separable sheets. The production of logs also implies the use of cardboard tubes, commonly called “cores” on whose surface a predetermined amount of glue is distributed to allow the paper web to be bonded onto the cores as it is introduced into the machine which produces the logs, commonly called “rewinder”. The glue is distributed on the cores when they pass along a corresponding path comprising an end section commonly known as “cradle” due to its concave shape. The formation of the logs further implies the use of winding rollers downstream of the cradle, which provoke the rotation of each core about its longitudinal axis thus determining the winding of the web on the same core. The process ends when a predetermined number of sheets is wound on the core, with the gluing of a flap of the last sheet on the underlying sheet of the roll thus formed (so-called “closing flap” operation). At this point, the log is unloaded from the rewinder and conveyed to a cutting machine that divides it into rolls of a predetermined length. The web of paper material, before being wound on the cores, is subjected to the action of the pre-cutting unit, that is, is subjected to the action of an apparatus that produces on the web a series of parallel incision lines corresponding to the so-called “tears”, determining the formation, on the finished product, of a series of parallel lines of incision that allow the detachment of the sheets.

For the execution of the pre-cutting lines on the paper web which feeds the rewinder, the same web is passed between a roller provided with a plurality of radially protruding blades and a corresponding counter-blade. The correct execution of the pre-cutting lines implies that there is a correct interference of the blades of the roller with the counter-blade.

Possible drawbacks connected with the execution of the pre-cutting lines can be related to the wear of one or more blades, as well as to the misalignment between the pre-cutting elements, or to an incorrect configuration of non-alignment and/or incorrect spacing between the roller and the counter-blade. In fact, the blades are subject to wearing and each blade can wear to a different extent with respect to the other blades of the same roller, thus causing an incorrect interaction between the pre-cutting elements; said incorrect interaction can also be determined by a possible variation of the optimal pre-cutting configuration set during assembly of the machine, due to variable reasons. Consequently, the finished product may exhibit defects consisting of inaccurate or in any case improperly executed pre-cutting lines which entail greater difficulties in the tear separation of the individual sheets.

Even slight variations in wear or in the positioning of the pre-cutting elements can cause unacceptable effects for the realization not only of a high level production, but also for achieving normal production quality standards.

The main object of the present invention is to eliminate, or in any case drastically reduce, the aforementioned drawbacks.

This result has been achieved, in accordance with the present invention, by means of an operative method and a machine having the features indicated in the independent claims. Other features of the present invention are the subject of the dependent claims.

Thanks to the present invention, it is possible to check the operating condition of the rotating blades and automatically signaling any anomaly with respect to a pre-set standard, allowing the operators, or automatic regulation devices, to intervene on the pre-cutting unit before the detected anomaly provokes defects on the logs being produced. Moreover, the control system used to implement the present invention can be achieved by means of a simple and economical circuital configuration in relation to the advantages offered. Another advantage of the present invention relates to the constant control of the blades interaction and the consequent substantially continuous regulation. which determines a longer duration because an abnormal wearing of the blades is substantially avoided. In other words, the signaling of the anomaly is no longer determined by the “downstream” detection of the defects presented by the web coming out of the pre-cutting unit, but is based on a real time control of the actual conditions of the blades, excluding in an almost absolute way incorrect operation conditions that can lead to damages to the machines and/or to the production of qualitatively unsuitable products.

A further advantage is that the operative method and the apparatus object of the invention can be applied to already existing plants without structural and functional excessively relevant modifications to the same plants. These and further advantages and features of the present invention will be better understood by any person skilled in the art, thanks to the following description and to the attached drawings, provided as an example but not to be considered in a limiting sense, in which:

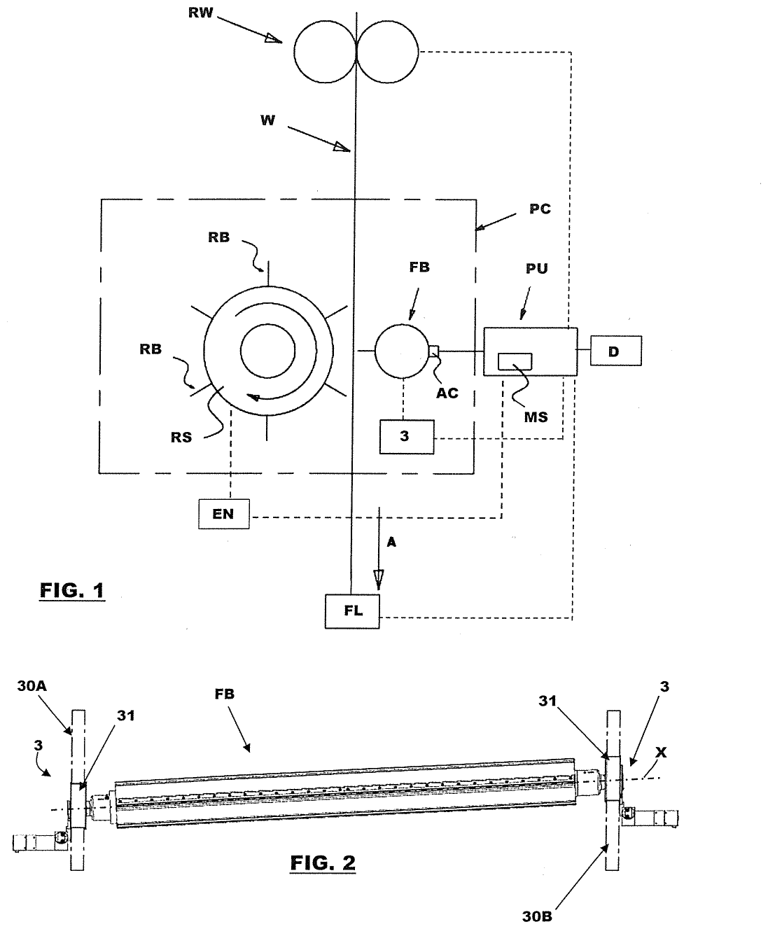

FIG. 1 schematically represents a pre-cutting unit equipped with a possible embodiment of a control device according to the present invention, in which the components are not in scale but shown only schematically or with blocks;

FIG. 2 represents a partial and schematic view of a detail of a pre-cutting unit relative to the counter blade roll;

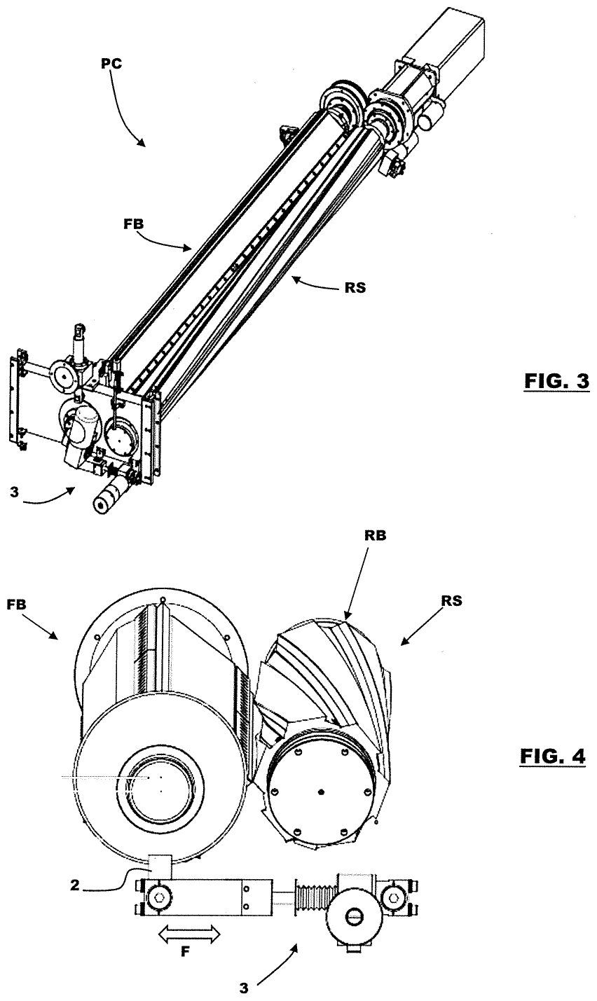

FIGS. 3 and 4 schematically represent a possible embodiment of a cutting roller and a counter-blade in a possible embodiment of a pre-cutting unit according to the invention.

Reduced to its essential structure and with reference to the accompanying exemplary drawings, a control device according to the present invention can be arranged in a known type of rewinder.

In particular, the control device is arranged and acting at the pre-cutting unit (PC), which, conventionally, is arranged downstream of the unwinding station (RW) of the reels that feed the web (W) to be wound up around the cores to make the logs and upstream of the means (FL) that wind the cores around the cores.

For simplicity, in the diagram of FIG. 1 the unwinding station is represented by two opposed rollers (RW), the web (W) is represented by a continuous line and the winding means are represented by a block (FL) arranged downstream of the pre-cutting unit (PC), along the path followed by the web (W) whose advancement direction is indicated by the arrow (A).

The pre-cutting unit (PC) comprises a roller (RS) which rotates at a predetermined speed around a relative axis (X) and has a plurality of blades (RB) projecting radially from its outer surface. The blades (RB) can be, for example, helically shaped blades extending from one base to the other of the roller (RS) and are spaced apart from each other by a predetermined value, as schematically represented in FIGS. 3 and 4. In according to the example shown in the accompanying drawings, the pre-cutting unit (PC) further comprises a counter-blade (FB) supported and projecting from a relative support (2) and oriented towards the roller (RS). The counter-blade (FB) shown in FIGS. 2, 3 and 4 is of the type provided with a plurality of counter-blades which can be used at different times, for example during replacement due to wear.

The roller (RS) and the counter-blade (FB) delimit a passage for the paper web (W) that passes through the unit (PC) as indicated by the arrow “A” in FIG. 1. During the pre-cutting phase, a blade (RB) of the roller (RS) interferes with the counter-blade (FB) while the web (W) passes between the blade and the counter-blade. This interference, as in conventional pre-cutting units, causes the formation of a pre-cutting line on the web (W) transversely to the direction (A) of the same web passing through the unit (PC).

The pre-cutting unit (PC) is supported by the sides of the rewinder, i.e. by lateral supports (which can be formed by the sides of the rewinder or can be other suitable supports) on which the shaft of the roller (RS) and the counter-blade (FB) are supported. Said lateral supports therefore constitute the support structure for the pre-cutting unit (PC).

The interference between each blade (RB) of the roller (RS) and the counter-blade (FB) produces a vibration that propagates along the support structure of the pre-cutting unit (PC) and is detected by a sensing device (AC) adapted to convert the vibration itself into an analog electric signal which, in turn, is converted into a digital signal by means of an A/D converter and is transmitted to a programmable processing unit (PU) which compares the amplitude of the signal thus received with a reference value stored in a memory section (MS) of the same programmable unit (PU). In general, the unit (PU) emits an alarm signal if the amplitude of the received signal is smaller or greater than the predetermined reference value.

For example, as will be better explained in the following of the present description, the amplitude of the received signal is lower than the predetermined reference value, the unit (PU) can attribute this condition to an insufficient interference between blade and counter-blade which can be due, for example, to excessive wear of the blade. If, on the other hand, the amplitude of the received signal is greater than the predetermined reference value, the unit (PU) can attribute this condition to an excessive interference between the blade and the counter-blade which may be due, for example, to a not correct mounting of the blade on the roller or to a geometric defect of the blade.

The sensing device (AC) may comprise an accelerometer of the SKF CMSS2200 type. However, sensor means (consisting of one or more sensing devices) of another type capable of detecting vibrations and emitting a signal according to the detected vibration can be provided. In general, it can be used a device capable of detecting the vibrations emitted by the interaction between the rollers (RS) and (FB), for example by detecting the inertia of a mass subjected to the corresponding acceleration, transforming the displacement of said mass into an electrical signal usable by the processing unit (PU). In other words, any sensor capable of converting vibrations deriving from the interaction between the roller and counter-blade into an electrical signal can be used.

Furthermore, by connecting an encoder (EN) to the shaft of the roller (RS) and to the processing unit (PU), it is also possible to identify which blade (RB) produces the abnormal vibration. In fact, by realizing this connection, the processing unit (PU) receives both the signals coming from the detection device (AC) and the position signals of the roller (RS) and, therefore, of the blades (RB), coming from the encoder (EN).

Tables Tab.1 and Tab.2 show data obtained experimentally by measuring the vibrations generated by the interference between the roller (RB) and the counter-blade (FB). In particular, the tables show the peaks corresponding to the blade frequency (f blade) and to the first four left side bands (values from −1 to −4), deriving them from the corresponding spectrum values, obtained respectively from a preliminary measure made without using the paper (Tab.1) and a preliminary measure made using the paper (Tab.2).

The preliminary measurement is a measurement carried out on the machine under operating conditions to define the so-called reference values, i.e. a measurement made before operating the machine, to establish which values are sensed by the sensor(s) at predetermined operating conditions which correspond to at least a correct configuration and to a series of incorrect configurations which may be due, for example, to the non-alignment between the roller and counter-blade, to an incorrect distance between the roller and counter-blade, etc.

In particular, with reference to the examples provided in the tables, values have been evaluated for the following configurations: correct or reference value, excessive interference, insufficient interference, roller skewing at the service side, roller skewing at the operator side, and blade-free interference. The top of each table provides the values as measured, while the lower part of the table provides the values in percentage with respect to the reference value.

In practice, the signals detected by the sensor means (and preferably suitably transformed) are used to define a sort of anomaly map capable of automatically allowing the repositioning of the machine to the correct values.

Any alarms (based on an amplitude value or a value derived from it Or related to it) that can be emitted by the unit (PU) can be advantageously differentiated according to the type of anomaly detected. These alarms can be both acoustic and luminous alarms and can include the emission of a text message or the production of a specific graphic symbol on a display (D) connected to the unit (PU).

TABLE 1

| | f_blade | −1 | −2 | −3 | −4 |
|---|---|---|---|---|---|
| Reference | 0.094 | 0.0083 | 0.0752 | 0.1205 | 0.2023 |
| value mm/s | | | | | |
| Excessive | 0.1668 | 0.0128 | 0.0971 | 0.1655 | 0.2417 |
| interference | | | | | |
| Insufficient | 0.04924 | 0.009254 | 0.08583 | 0.09515 | 0.2408 |
| interference | | | | | |
| Skewing | 0.08035 | 0.00762 | 0.08507 | 0.1213 | 0.3406 |
| operator | | | | | |
| side | | | | | |
| Skewing | 0.05232 | 0.007915 | 0.08996 | 0.1046 | 0.2461 |
| motor side | | | | | |
| Blade-free | 0.0728 | 0.002744 | 0.09058 | 0.03646 | 0.2621 |
| Reference | 0.094 | 0.0083 | 0.0752 | 0.1205 | 0.2023 |
| value mm/s | | | | | |
| Excessive | +77.7% | +54.2% | +29.1% | +37.3% | +19.4% |
| interference | | | | | |
| Insufficient | −47.8% | +11.5% | +14.1% | −21% | +19% |
| interference | | | | | |
| Skewing | −14.9% | −8.2% | +13.1% | +0.66% | +68.3% |
| operator | | | | | |
| side | | | | | |
| Skewing | −44.6% | −4.6% | +19.6% | −13.1% | +21.6% |
| motor side | | | | | |
| Blade-free | −22.3% | −66.94% | +27.4% | −69.7% | +29.5% |

TABLE 2

| | f_blade | −1 | −2 | −3 | −4 |
|---|---|---|---|---|---|
| Reference | 0.1861 | 0.0285 | 0.07358 | 0.1825 | 0.02112 |
| value mm/s | | | | | |
| Excessive | 0.3586 | 0.05272 | 0.08663 | 0.3098 | 0.02136 |
| interference | | | | | |
| Insufficient | 0.1027 | 0.0236 | 0.09396 | 0.2005 | 0.0201 |
| interference | | | | | |
| Skewing | 0.1705 | 0.0325 | 0.1022 | 0.2224 | 0.01735 |
| operator | | | | | |
| side | | | | | |
| Skewing | 0.1207 | 0.05683 | 0.0478 | 0.1782 | 0.02387 |
| motor side | | | | | |
| Blade-free | not | not | not | not | not |
| | acquired | acquired | acquired | acquired | acquired |
| Reference | 0.1861 | 0.0285 | 0.07358 | 0.1825 | 0.02112 |
| value mm/s | | | | | |
| Excessive | +92.7% | +85% | +17.7% | +69.7% | +1.1% |
| interference | | | | | |
| Insufficient | −44.8% | −17.2% | +27.7% | +9.9% | −4.8% |
| interference | | | | | |
| Skewing | −8.4% | +14% | +38.9% | +21.9% | −11.4% |
| operator | | | | | |
| side | | | | | |
| Skewing | −35.1% | +99.4% | −35% | −2.4% | +13% |
| motor side | | | | | |
| Blade-free | not | not | not | not | not |
| | acquired | acquired | acquired | acquired | acquired |

The operative method object of the invention provides a step of setting the reference values which, stored (for example in one or more files) in the memory (MS), will be used by the processing unit (PU) for checking the correct positioning of the pre-cutting unit (PC) elements.

In particular, the sensor means may comprise vibration detectors, arranged on the pre-cutting station in a convenient position. For example, they can be fixed to a wall of the pre-cutting station, sideways or at an intermediate point with respect to the rollers (RS) and (FB).

In practice, after the assembly of the plant and the pre-cutting station (PC), the same plant is started to measure the vibration values under “normal” conditions, i.e. by making the rollers to interact, for example without or (preferably but not exclusively) with the paper web (W) that passes between said rollers and is subjected to pre-cut.

The detected vibrations are due to the contacts (or collisions) that occur due to the interaction of the rollers. The measured values can be directly used by the processing unit (PU), or they can be transformed using, for example, the relative harmonics, as in the tables described above. For example, the reference values may comprise the sum of several graphs, relative to the successive harmonics, so as to make the spectrum of the values provided as complete as possible. In practice, the method and apparatus of the invention provide a sort of “fingerprint” of the vibration which can be obtained directly from the detected vibrations or by a suitable transformation and which is memorized for the subsequent comparison during the production phase of the machine.

After starting the pre-cutting elements and setting the reference values, the system is operated in the production mode and the detection means are activated to provide the processing unit with the related data.

Advantageously, the same detection means used for providing the reference values during the preliminary measurement are also used to monitor the correct operation of the machine. In this way the detection is as precise as possible because the means used for the preliminary measurement correspond to those used for monitoring the production mode.

On case of incorrect measurements but anyway included in a range of “standard” values that correspond to the non-optimal functioning but that can be corrected, the unit (PU) emits an alarm signal that can determine, even automatically, the repositioning the pre-cutting members (PC) until the detection of standard reference values is reached.

On the contrary, during detections not included in this range, the unit (PU) emits an alarm signal that can determine, even automatically, the stopping of the pre-cutting members (PC) if the values exceed pre-established thresholds.

In the drawings, the means allowing the automatic repositioning of the pre-cutting unit (PC) are shown as motor means (3) acting on the counterblade (FB) and are apt to move it bi-directionally, for example according to the double arrow (F). Experimental tests have shown that it can be more effective to move this element (FB) which in the drawings is schematically shown as supported by two movable brackets (31) along corresponding guide elements, or, preferably, is supported by cam means allowing to more effectively regulating the positioning of said blade-holder roller.

In particular, with reference to the non-limiting example shown in the drawings, the repositioning of the pre-cutting elements can take place by sending control signals to the positioning means of the blade-holder roller (FB) acting on two opposing faces, indicated by (30A) and (30B) in the drawings. In other words, the control unit (PU) is able to drive the motor means destined to the positioning/orientation of this roller.

In the diagram of FIG. 1 the control unit (PU) is also connected to the unwinding station (RW) and to the winding means (FL) arranged downstream. This means that in the event of detection of a fault that cannot be corrected by repositioning the pre-cutting rollers, the control system can stop the operation of the rewinder both upstream and downstream of the pre-cutting unit. In other words, the monitoring system has the possibility of automatically remedying anomalies of a certain type such as, for example, the separation of the two rollers or their incorrect spacing, while the occurrence of anomalies that cannot be corrected by the action of the means (3) for positioning the rollers (for example breakage or excessive consumption of a blade), is able to send a stop signal both to the pre-cutting means and to the other components of the rewinder.

In practice, the details of execution may in any case vary in any equivalent manner as regards the individual elements described and illustrated without departing from the scope of the solution idea adopted and therefore remaining within the limits of the protection conferred by the present patent.

1-12. (canceled)

13. A method for checking the correct operation of a pre-cutting device in a plant for the production of logs of paper material, the device being provided with at least a first rotating element or first roller that interacts with a second element or counter-blade for forming, by means of at least one blade, a succession of pre-cut lines on a ribbon of paper material, the method comprising:
realization and assembly of the pre-cutting device, with relative positioning and adjustment of said first and second rotating elements;
activation of the pre-cutting device with a measurement of vibrations emitted relating to an interaction between said first and said second rotating elements during a test step that precedes operative use of the device;
storage of at least a value or a set of values related to said vibrations measurement, corresponding to an optimal or reference operating configuration of the device, said storage being executed during said test step;
measuring, during operation of said plant, values of the vibrations emitted by the interaction between said first and second rotating elements and comparison with said value or set of values related to the reference operating configuration, with an emission of a signal if there is a non-correspondence between the detected values and the reference value or set of reference values.

14. Method according to claim 13 wherein said set of values constitutes a range of reference values and in that said comparison determines whether the value is in this range-.

15. Method according to claim 13 wherein said emitted signal at the non-correspondence between the detected value and the reference value or set of reference values is sent to automatic means for adjusting the position of one of said first and second element, adapted to vary the distance and/or inclination of one of the two elements relative to each other.

16. Method according to claim 15, wherein the adjustment of said first and second element is executed by at least two positioning means arranged and/or acting on opposite sides with respect to the longitudinal development of said elements.

17. Method according to claim 13, wherein the determination of said reference value or set of reference values is performed by passing a ribbon of paper material between said first and second element and by measuring the values of related vibrations.

18. Method according to claim 13, wherein the values of the detected vibrations are used in the form of a function of time or of the relative transforms.

19. Method according to claim 13, in which the action of said first rotating element or first roller is performed by a plurality of blades, and it comprises the detection of the position of the first element by providing a signal of the position of the roller to correlate the measurement performed to a blade of said plurality.

20. Method according to claim 13, wherein the means used for defining the said reference value are the same as those used during the operation of the machine.

21. Method according to claim 13, wherein the action of the pre-cutting means is realized downstream of an unwinding station and upstream of a winding means, further comprising arresting said unwinding station and/or said winding means when a detected value exceeds a threshold.

22. Rewinding machine for the production of logs of paper material, comprising: means for feeding a paper web formed by one or more superposed webs along a predetermined feed path, a pre-cutting unit disposed along said feed path and adapted to produce on the passing tape a series of transverse pre-cutting lines, winding means, arranged downstream of the pre-cutting unit, for winding the paper web in the form of log or roll having a pre-fixed length in a winding station, and means for discharging the log from the winding station, in which the pre-cutting unit comprises a predetermined number of blades that by interfering with a counter-blade produce the said pre-cut lines on the tape, further comprising it comprises: a detection device for detecting the vibrations produced by the interference between the blades and the counter-blade in the production phase of the pre-cutting lines and adapted to produce electrical signals representative of said vibrations; and a programmable processing unit which receives the signals produced by the detection device and compare the values of the signals detected with reference values acquired during a test step involving the pre-cutting device for emitting an alarm signal if one of said detected values is outside of an interval delimited by the reference values.

23. Rewinding machine for the production of logs of paper material according to claim 22, wherein said programmable processing unit is connected to positioning means of a support roller of said counter-blade and/or of said predetermined number of blades so as to automatically adjust its positioning as a function of the detections performed by said detection device.

24. Rewinding machine for the production of logs of paper material according to claim 22, wherein said programmable processing unit is connected to said means for feeding a paper web and said winding means, so as to deactivate the operation in function of the detections performed by said detection device.
